(19) United States
(12) Patent Application Publication
(10) Pub. No.: US 2025/0391306 A1
(43) Pub. Date: Dec. 25, 2025

(54) DISPLAY DEVICE, ELECTRONIC DEVICE INCLUDING THE SAME, AND COMPENSATION METHOD THEREOF

(71) Applicant: Samsung Display Co., Ltd., Yongin-si (KR)

(72) Inventors: Hee Kwang SONG, Yongin-si (KR); Hee Kyung KIM, Yongin-si (KR); Joung Keun PARK, Yongin-si (KR); Sang Kyung LEE, Yongin-si (KR)

(21) Appl. No.: 19/206,977

(22) Filed: May 13, 2025

(30) Foreign Application Priority Data
Jun. 24, 2024 (KR) 10-2024-0081968

(51) Int. Cl. G09G 3/20; G09G 3/3233

(52) U.S. Cl. CPC G09G 3/2007; G09G 3/2096; G09G 3/3233; G09G 2300/0842; G09G 2320/045; G09G 2360/16

(57) ABSTRACT

A compensation method of a display device includes storing a compensation value over time from a first time point to a third time point for a first gray scale based on a deterioration curve of a first gray scale, and storing a compensation value over time from a second time point to a fifth time point, based on the deterioration curve of the first gray scale. In the display device, the electronic device, and the compensation method thereof, it is possible to efficiently calculate the compensation value of the light-emitting element, and to compensate for deterioration of the light-emitting element.

### CROSS-REFERENCE TO RELATED APPLICATION

The present application claims priority to, and the benefit of, Korean Patent Application No. 10-2024-0081968, filed on Jun. 24, 2024, in the Korean Intellectual Property Office, the entire disclosure of which is incorporated herein by reference.

### BACKGROUND

### 1. Field

Embodiments of the present disclosure relate to a display device, an electronic device including the same, and a compensation method thereof.

### 2. Description of the Related Art

With the development of information technology, the importance of display devices, which are connection media between users and information, has been emphasized. Owing to the importance of display devices, the use of various kinds of display devices, such as liquid crystal display devices and organic light-emitting display devices, has increased.

A display device may include a light-emitting element (e.g., an organic light-emitting element). The light-emitting element may deteriorate while being driven. If the light-emitting element deteriorates, the luminance thereof may decrease even if the same amount of current flows therethrough. Therefore, to compensate for the deterioration of the light-emitting element, it may be suitable to calculate a compensation value over time.

SUMMARY

The present disclosure provides a display device capable of efficiently calculating a compensation value of a light-emitting element and compensating for deterioration of the light-emitting element, and a compensation method thereof.

In accordance with embodiments of the present disclosure, a compensation method of a display device may include measuring a luminance of a first gray scale image at a first time point, measuring a luminance of a second gray scale image at a second time point, measuring the luminance of the first gray scale image at a third time point when a first period has elapsed from the first time point, measuring the luminance of the second gray scale image at a fourth time point when the first period has elapsed from the second time point, plotting a luminance change of the first gray scale image over time from the first time point to the third time point, obtaining a deterioration curve of a first gray scale, plotting a scaled luminance change of the second gray scale image over time from the second time point to the fourth time point on the deterioration curve of the first gray scale, obtaining a fifth time point at which the luminance of the second gray scale image reaches a target deterioration luminance on the deterioration curve of the first gray scale image based on a result of plotting the scaled luminance change of the second gray scale image over time, storing a compensation value over time from the first time point to the third time point for the first gray scale based on the deterioration curve of the first gray scale, and storing a compensation value over time from the second time point to the fifth time point based on the deterioration curve of the first gray scale.

The first gray scale may be lower than the second gray scale.

The luminance of the first gray scale image measured at the third time point may be equal to the target deterioration luminance.

The luminance of the second gray scale image measured at the fifth time point may be equal to the target deterioration luminance.

The luminance of the first gray scale image measured at the first time point may be about 100%, and the luminance of the first gray scale image measured at the third time point may be 50%.

The luminance of the second gray scale image measured at the second time point may be about 100%, and the luminance of the second gray scale image measured at the fifth time point may be about 50%.

The luminance of the second gray scale image measured at the fourth time point may be greater than about 50% and less than about 100%.

The compensation method may further include storing compensation values over time for gray scales between the first gray scale and the second gray scale based on the deterioration curve of the first gray scale.

The compensation value over time from the first time point to the third time point, and the compensation value over time from the second time point to the fifth time point, may be stored as a look-up table.

The first gray scale may be a 64 gray scale.

In accordance with embodiments of the present disclosure, a display device may include a display panel, sub-pixels on the display panel, a data-driving circuit configured to sense a degree of deterioration of the sub-pixels, and to supply a data voltage to the sub-pixels, and a timing controller configured to receive first image data, and to output, to the data-driving circuit, second image data obtained by compensating the first image data based on a compensation value over time that is stored for gray scales according to the degree of deterioration of the sub-pixels, wherein the compensation value over time that is stored for the gray scales includes a compensation value for a first gray scale and a compensation value for a second gray scale, and wherein the compensation value for the second gray scale is based on the compensation value for the first gray scale.

The first gray scale may be lower than the second gray scale.

The compensation value for the first gray scale may be based on a deterioration curve of the first gray scale obtained by plotting a luminance change of the first gray scale over time from a first time point to a third time point.

A luminance of a first gray scale image at the third time point may be half of a luminance of the first gray scale image at the first time point.

A fifth time point may be obtained by plotting the compensation value for the second gray scale on the deterioration curve of the first gray scale by scaling a luminance change of the second gray scale over time from a second time point to a fourth time point, wherein a compensation value of the second gray scale over time obtained from the second time point to the fifth time point based on the deterioration curve of the first gray scale is configured to be stored.

A luminance of a second gray scale image at the fifth time point may be half of a luminance of the second gray scale image at the second time point.

A luminance of a second gray scale image at the fourth time point may be greater than a luminance of the second gray scale image at the fifth time point, and less than luminance of the second gray scale image at the second time point.

The first gray scale may be a 64 gray scale, wherein the second gray scale is greater than a 64 gray scale and less than or equal to a 255 gray scale.

The timing controller may include a memory in which a look-up table is stored, the look-up table storing a compensation value over time for the gray scales.

The look-up table may include a gray scale column, a time column, a deterioration luminance column, and a compensation value column.

In accordance with embodiments of the present disclosure, an electronic device includes a host configured to output a first image data, a display panel, sub-pixels on the display panel, a data-driving circuit configured to sense a degree of deterioration of the sub-pixels, and to supply a data voltage to the sub-pixels, and a timing controller configured to receive the first image data, and to output, to the data-driving circuit, second image data obtained by compensating the first image data based on a compensation value over time that is stored for gray scales according to the degree of deterioration of the sub-pixels, wherein the compensation value over time that is stored for the gray scales comprises a compensation value for a first gray scale and a compensation value for a second gray scale, and wherein the compensation value for the second gray scale is based on the compensation value for the first gray scale.

The electronic device may include a smartphone, a television, a monitor, a tablet, an electric vehicle, a mobile phone, a tablet personal computer (PC), a mobile communication terminal, an electronic notebook, an electronic book, a portable multimedia player (PMP), a navigation device, an ultra-mobile PC (UMPC), a laptop computer, a billboard, an Internet of Things (IoT) device, a smartwatch, a watch phone, or a head-mounted display (HMD).

### BRIEF DESCRIPTION OF THE DRAWINGS

FIG. 1 is a system block diagram of a display device in accordance with embodiments of the present disclosure.

FIG. 2 is a conceptual diagram of a display area in accordance with embodiments of the present disclosure.

FIG. 3 is an equivalent circuit diagram of a sub-pixel in accordance with embodiments of the present disclosure.

FIG. 4 is a diagram showing a luminance change curve over time.

FIG. 5 illustrates one or more embodiments of a look-up table including compensation values over time for a first gray scale.

FIG. 6 is a diagram showing a luminance change curve over time for each gray scale.

FIG. 7 is a diagram showing a scaled luminance change over time for each gray level.

FIG. 8 is a flowchart of a compensation method of a display device in accordance with embodiments of the present disclosure.

### DETAILED DESCRIPTION

Aspects of some embodiments of the present disclosure and methods of accomplishing the same may be understood more readily by reference to the detailed description of embodiments and the accompanying drawings. The described embodiments are provided as examples so that this disclosure will be thorough and complete, and will fully convey the aspects of the present disclosure to those skilled in the art. Accordingly, processes, elements, and techniques that are redundant, that are unrelated or irrelevant to the description of the embodiments, or that are not necessary to those having ordinary skill in the art for a complete understanding of the aspects of the present disclosure may be omitted. Unless otherwise noted, like reference numerals, characters, or combinations thereof denote like elements throughout the attached drawings and the written description, and thus, repeated descriptions thereof may be omitted.

The described embodiments may have various modifications and may be embodied in different forms, and should not be construed as being limited to only the illustrated embodiments herein. The use of “can,” “may,” or “may not” in describing an embodiment corresponds to one or more embodiments of the present disclosure.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In the drawings, the relative sizes of elements, layers, and regions may be exaggerated for clarity and/or descriptive purposes. In other words, because the sizes and thicknesses of elements in the drawings are arbitrarily illustrated for convenience of description, the disclosure is not limited thereto.

Spatially relative terms, such as “beneath,” “below,” “lower,” “lower side,” “under,” “above,” “upper,” “over,” “higher,” “upper side,” “side” (e.g., as in “sidewall”), and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below,” “beneath,” “or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly. Similarly, when a first part is described as being arranged “on” a second part, this indicates that the first part is arranged at an upper side or a lower side of the second part without the limitation to the upper side thereof on the basis of the gravity direction.

It will be understood that when an element, layer, region, or component (e.g., an apparatus, a device, a circuit, a wire, an electrode, a terminal, a conductive film, etc.) is referred to as being “formed on,” “on,” “connected to,” or “(operatively, functionally, or communicatively) coupled to” another element, layer, region, or component, it can be directly formed on, on, connected to, or coupled to the other element, layer, region, or component, or indirectly formed on, on, connected to, or coupled to the other element, layer, region, or component such that one or more intervening elements, layers, regions, or components may be present. In addition, this may collectively mean a direct or indirect coupling or connection and an integral or non-integral coupling or connection. For example, when a layer, region, or component is referred to as being “electrically connected” or “electrically coupled” to another layer, region, or component, it can be directly electrically connected or coupled to the other layer, region, and/or component or one or more intervening layers, regions, or components may be present. The one or more intervening components may include a switch, a transistor, a resistor, an inductor, a capacitor, a diode and/or the like. Accordingly, a connection is not limited to the connections illustrated in the drawings or the detailed description and may also include other types of connections. In describing embodiments, an expression of connection indicates electrical connection unless explicitly described to be direct connection, and “directly connected/directly coupled,” or “directly on,” refers to one component directly connecting or coupling another component, or being on another component, without an intermediate component. Meanwhile, other expressions describing relationships between components, such as “between,” “immediately between” or “adjacent to” and “directly adjacent to,” may be construed similarly. It will be understood that when an element or layer is referred to as being “between” two elements or layers, it can be the only element or layer between the two elements or layers, or one or more intervening elements or layers may also be present.

For the purposes of this disclosure, expressions such as “at least one of,” or “any one of,” or “one or more of” when preceding a list of elements, modify the entire list of elements and do not modify the individual elements of the list. For example, “at least one of X, Y, and Z,” “at least one of X, Y, or Z,” “at least one selected from the group consisting of X, Y, and Z,” and “at least one selected from the group consisting of X, Y, or Z” may be construed as X only, Y only, Z only, any combination of two or more of X, Y, and Z, such as, for instance, XYZ, XYY, YZ, and ZZ, or any variation thereof. Similarly, the expressions “at least one of A and B” and “at least one of A or B” may include A, B, or A and B. As used herein, “or” generally means “and/or,” and the term “and/or” includes any and all combinations of one or more of the associated listed items. For example, the expression “A and/or B” may include A, B, or A and B. Similarly, expressions such as “at least one of,” “a plurality of,” “one of,” and other prepositional phrases, when preceding a list of elements, modify the entire list of elements and do not modify the individual elements of the list. When “C to D” is stated, it means C or more and D or less, unless otherwise specified.

It will be understood that, although the terms “first,” “second,” “third,” etc., may be used herein to describe various elements, components, regions, layers and/or sections, these elements, components, regions, layers and/or sections should not be limited by these terms. These terms do not correspond to a particular order, position, or superiority, and are used only used to distinguish one element, member, component, region, area, layer, section, or portion from another element, member, component, region, area, layer, section, or portion. Thus, a first element, component, region, layer or section described below could be termed a second element, component, region, layer or section, without departing from the spirit and scope of the present disclosure. The description of an element as a “first” element may not require or imply the presence of a second element or other elements. The terms “first,” “second,” etc. may also be used herein to differentiate different categories or sets of elements. For conciseness, the terms “first,” “second,” etc. may represent “first-category (or first-set),” “second-category (or second-set),” etc., respectively.

In the examples, the x-axis, the y-axis, and/or the z-axis are not limited to three axes of a rectangular coordinate system, and may be interpreted in a broader sense. For example, the x-axis, the y-axis, and the z-axis may be perpendicular to one another, or may represent different directions that are not perpendicular to one another. The same applies for first, second, and/or third directions.

The terminology used herein is for the purpose of describing embodiments only and is not intended to be limiting of the present disclosure. As used herein, the singular forms “a” and “an” are intended to include the plural forms as well, while the plural forms are also intended to include the singular forms, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof.

As used herein, the terms “substantially,” “about,” “approximately,” and similar terms are used as terms of approximation and not as terms of degree, and are intended to account for the inherent deviations in measured or calculated values that would be recognized by those of ordinary skill in the art. For example, “substantially” may include a range of +/−5% of a corresponding value. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value. Further, the use of “may” when describing embodiments of the present disclosure refers to “one or more embodiments of the present disclosure.” Furthermore, the expression “being the same” may mean “being substantially the same”. In other words, the expression “being the same” may include a range that can be tolerated by those of ordinary skill in the art. The other expressions may also be expressions from which “substantially” has been omitted.

In some embodiments well-known structures and devices may be described in the accompanying drawings in relation to one or more functional blocks (e.g., block diagrams), units, and/or modules to avoid unnecessarily obscuring various embodiments. Those skilled in the art will understand that such block, unit, and/or module are/is physically implemented by a logic circuit, an individual component, a microprocessor, a hard wire circuit, a memory element, a line connection, and other electronic circuits. This may be formed using a semiconductor-based manufacturing technique or other manufacturing techniques. The block, unit, and/or module implemented by a microprocessor or other similar hardware may be programmed and controlled using software to perform various functions discussed herein, optionally may be driven by firmware and/or software. In addition, each block, unit, and/or module may be implemented by dedicated hardware, or a combination of dedicated hardware that performs some functions and a processor (for example, one or more programmed microprocessors and related circuits) that performs a function different from those of the dedicated hardware. In addition, in some embodiments, the block, unit, and/or module may be physically separated into two or more interact individual blocks, units, and/or modules without departing from the scope of the present disclosure. In addition, in some embodiments, the block, unit and/or module may be physically combined into more complex blocks, units, and/or modules without departing from the scope of the present disclosure.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Hereinafter, embodiments of the present disclosure will be described in described in detail with reference to the drawings.

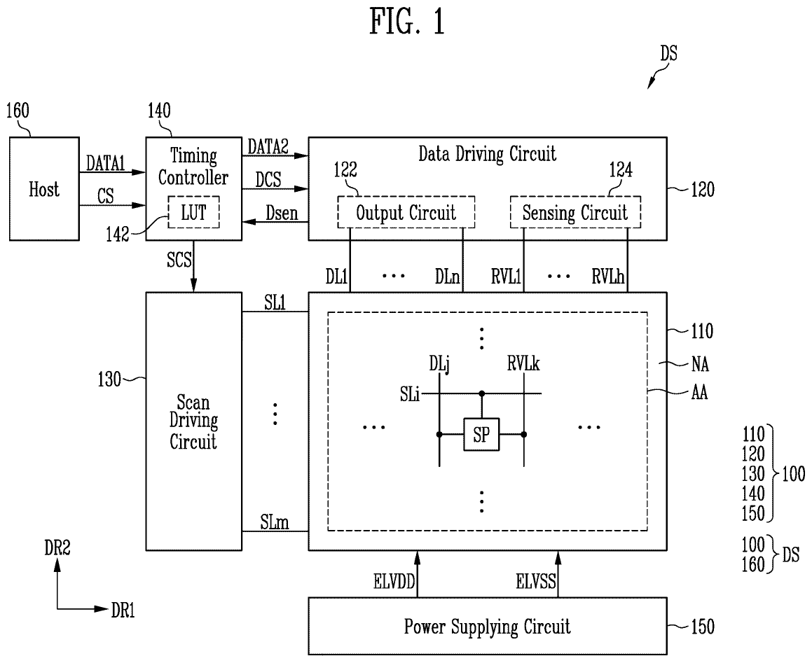

FIG. 1 is a system block diagram of a display device 100 in accordance with embodiments of the present disclosure.

Referring to FIG. 1, the display device 100 in accordance with embodiments of the present disclosure may include a display panel 110, a data-driving circuit 120, a scan-driving circuit 130, a timing controller 140, a power supply circuit 150, and the like.

A plurality of sub-pixels SP may be arranged on the display panel 110. A plurality of data lines DL1 to DLn (where n is an integer greater than or equal to 2) electrically connected to the plurality of sub-pixels SP, a plurality of scan lines SL1 to SLm (where m is an integer greater than or equal to 2), and a plurality of reference voltage lines RVL1 to RVLh (where h is an integer greater than or equal to 2), and the like may be arranged on the display panel 110. One or more power supply voltage lines configured to apply power supply voltages (e.g., a first power supply voltage ELVDD, a second power supply voltage ELVSS, etc.) to the plurality sub-pixels SP may be arranged on the display panel 110.

The display panel 110 may include a display area AA in which the plurality sub-pixels SP are arranged, and a non-display area NA located around the display area AA (e.g., at the edge of the display area AA).

The display panel 110 may be formed to be flat, but embodiments of the present disclosure are not limited thereto. For example, the display panel 110 may include curved portions formed at left and right ends. The curved surface may have a constant curvature or a changing curvature. In addition, the display panel 110 may be flexibly formed so that the display panel 110 can be curved, bent, folded, or rolled.

The plurality of sub-pixels SP may be arranged in the display area AA in a matrix type. In accordance with embodiments, the plurality of sub-pixels SP may be arranged in the display area AA in a PENTILE™ type or an RGB type (PENTILE™ being a registered trademark of Samsung Display Co., Ltd., Republic of Korea).

The plurality of data lines DL1 to DLn may extend in one direction from the display panel 110. The one direction may be, for example, a second direction DR2. The plurality of data lines DL1 to DLn may be arranged to extend in the second direction DR2 from the display panel 110 (e.g., in the second direction DR2 as a whole). The second direction DR2 may be, for example, a direction crossing from the upper side to the lower side of the display panel 110, but embodiments of the present disclosure are not limited thereto.

The plurality of scan lines SL1 to SLm may extend in one direction from the display panel 110. The one direction may be, for example, a first direction DR1. The plurality of scan lines SL1 to SLm may be arranged to extend in the first direction DR1 from the display panel 110 (e.g., in the first direction DR1 as a whole). The first direction DR1 may be a different direction from the second direction DR2, but embodiments of the present disclosure are not limited thereto. The first direction DR1 may be, for example, a direction crossing from the left side to the right side of the display panel 110.

The plurality of reference voltage lines RVL1 to RVLh may extend in one direction from the display panel 110. In one or more embodiments, the plurality of reference voltage lines RVL1 to RVLh may be arranged to extend in the second direction DR2 (e.g., in the second direction DR2 as a whole). However, embodiments of the present disclosure are not limited thereto.

The data-driving circuit 120 may include an output circuit 122 and a sensing circuit 124. In one or more embodiments, the output circuit 122 and the sensing circuit 124 may be arranged to be functionally separate from each other within the same integrated circuit. In accordance with embodiments, the output circuit 122 and the sensing circuit 124 may be arranged in different integrated circuits.

The output circuit 122 may be configured to supply a data voltage to the plurality of data lines DL1 to DLn. The output circuit 122 may generate the data voltage based on second image data DATA2 and a data-driving circuit control signal DCS, and may output the generated data voltage to the plurality of data lines DL1 to DLn in synchronization with a timing. The data-driving circuit control signal DCS may include, for example, a source start pulse (SSP), a source shift clock (SSC), a source output enable (SOE) signal, and the like.

The sensing circuit 124 is configured to input a reference voltage to the plurality of reference voltage lines RVL1 to RVLh in response to the data-driving circuit control signal DCS, and may sense the voltages of the plurality of reference voltage lines RVL1 to RVLh. The sensing circuit 124 may convert the sensed analog voltage into a sensing value Dsen of a corresponding digital value. The sensing circuit 124 may include one or more analog-to-digital converters (ADCs).

The data-driving circuit 120 may be implemented as an integrated circuit (e.g., a source driver integrated circuit (SDIC)) formed separately from the display panel 110, and may be formed together with the display panel 110 and formed in at least a portion of the non-display area NA of the display panel 110.

The scan-driving circuit 130 is configured to output a scan signal to the plurality of scan lines SL1 to SLm in response to a scan-driving circuit control signal SCS. The scan-driving circuit control signal SCS may include a start signal indicating the start of frame, a horizontal synchronization signal for outputting the scan signal in synchronization with a timing at which the data voltage is applied, and the like.

The scan-driving circuit 130 may be implemented as an integrated circuit (e.g., a gate driver integrated circuit (GDIC)) formed separately from the display panel 110, and may be formed together with the display panel 110 and formed in at least a portion of the non-display area NA of the display panel 110.

The timing controller 140 may be configured to control the data-driving circuit 120 and the scan-driving circuit 130. The timing controller 140 may generate and output the control signals DCS and SCS for controlling the data-driving circuit 120 and the scan-driving circuit 130 based on a control signal CS (e.g., a synchronization signal, a clock signal, a data enable signal, etc.) received through a host 160. In accordance with one or more embodiments, the timing controller 140 may generate the synchronization signal, the data enable signal, etc. therein, based on the control signal CS (e.g., information about the driving frequency (or frame rate) of an image displayed on the display panel 110) received through the host 160.

The timing controller 140 may receive first image data DATA1 from the host 160, and may align the received first image data DATA1 in units of pixel rows. The timing controller 140 may convert the received first image data DATA1 according to an interface (e.g., preset interface, such as low voltage differential signaling (LVDS), display port (DP), embedded display port (eDP), etc.). Second image data DATA2 that the timing controller 140 outputs to the data-driving circuit 120 may be data converted within the timing controller 140 according to the interface.

The timing controller 140 may generate the second image data DATA2 based on the first image data DATA1 and the sensing value Dsen. The second image data DATA2 may be data obtained by compensating for changes in the characteristics of the sub-pixels SP (e.g., changes in the characteristics due to deterioration of transistors or light-emitting elements within the sub-pixels SP).

In accordance with embodiments, the timing controller 140 is a logic type, and may be arranged within the display device 100. In accordance with embodiments, the timing controller 140 is a processor type, and may be arranged within the display device 100. The timing controller 140 may include one or more memories (e.g., registers, etc.).

The timing controller 140 may include a memory 142. A look-up table LUT for compensating for luminance changes over time for each gray scale may be stored in the memory 142. In one or more embodiments, the timing controller 140 may compensate the first image data DATA1 by referring to the look-up table LUT, and may output the second image data DATA2 including the compensated value. The data-driving circuit 120 may receive the second image data DATA2.

The power supply circuit 150 may be configured to output a constant voltage of a constant voltage level. The power supply circuit 150 may output the power supply voltage (e.g., the first power supply voltage ELVDD, the second power supply voltage ELVSS, etc.) supplied to the display panel 110. In accordance with one or more embodiments, the power supply circuit 150 may output a voltage (e.g., a gate high voltage, a gate low voltage, etc.) supplied to the scan-driving circuit 130. In accordance with one or more embodiments, the power supply circuit 150 may output a voltage (e.g., a gamma voltage, a reference voltage, etc.) supplied to the data-driving circuit 120. The power supply circuit 150 may include, for example, a regulator (e.g., a low dropout (LDO) regulator, etc.). The power supply circuit 150 may be implemented as, for example, a power management integrated circuit (PMIC).

The host 160 may include a set-top box, an application processor (AP), etc. In one or more embodiments, the host 160 may be an external element of the display device 100 that is not included in the display device 100. In one or more embodiments, the host 160 may be mounted within the display device 100. The first image data DATA1 and the control signal CS may be transmitted and received between the host 160 and the display device 100 through an interface. The interface may be, for example, a serial programming interface (SPI), an inter integrated circuit (I2C), a mobile industry processor interface (MIPI), etc. However, embodiments of the present disclosure are not limited thereto.

An electronic device DS in accordance with embodiments of the present disclosure may include the display device 100 and the host 160.

In FIG. 1, circuits that supply the signals, the voltages, and the like to the display panel 110 may be classified according to function. For example, the data-driving circuit 120 and the timing controller 140 may be formed within one integrated circuit. The data-driving circuit 120 and the timing controller 140 may be classified within one integrated circuit in display device 100 according to function.

The display device 100 in accordance with embodiments of the present disclosure may be used as a display screen for a portable electronic device, such as a mobile phone, a smartphone, a tablet personal computer (PC), a smart watch, a watch phone, a mobile communication terminal, an electronic organizer, an e-book, a portable multimedia player (PMP), a navigation system, and an ultra-mobile PC (UMPC), and may be used as display screens for various products, such as a television, a laptop, a monitor, a billboard, and an Internet of Things (IoT) device.

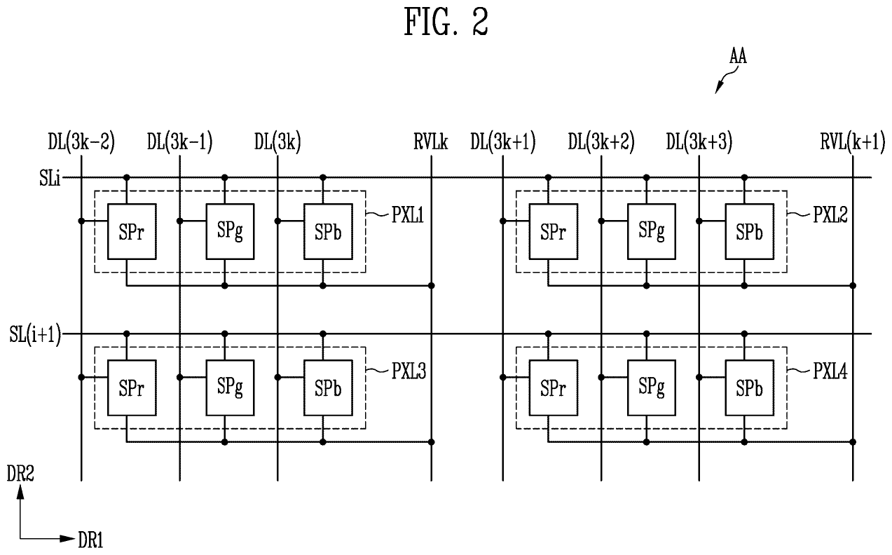

FIG. 2 is a conceptual diagram of the display area AA in accordance with embodiments of the present disclosure.

Referring to FIG. 2, a plurality of pixels arranged in a matrix type (e.g., first to fourth pixels PXL1, PXL2, PXL3, and PXL4 (also referred to as PXL1 to PXL4) are illustrated. Referring to FIG. 2, four pixels PXL1 to PXL4 may be arranged adjacent to each other in a horizontal direction (or a row direction) or may be adjacent to each other in a vertical direction (or a column direction).

Any one of the four pixels PXL1 to PXL4 (e.g., the first pixel PXL1 located at the upper left) may include a plurality sub-pixels. In one or more embodiments, the first pixel PXL1 may include a first color sub-pixel, a second color sub-pixel, and a third color sub-pixel. In one or more embodiments, the first color sub-pixel may be a red sub-pixel SPr. The second color sub-pixel may be a green sub-pixel SPg. The third color sub-pixel may be a blue sub-pixel SPb. However, embodiments of the present disclosure are not limited thereto. For example, the first pixel PXL1 may further include a white sub-pixel.

Hereinafter, for convenience of explanation, the display area AA is described centered on the four pixels PXL1 to PXL4 arranged in two rows and two columns. One or more embodiments in which the four pixels PXL1 to PXL4 each include a red sub-pixel SPr, a green sub-pixel SPg, and a blue sub-pixel SPb is described as an example. However, embodiments of the present disclosure are not limited thereto. The three sub-pixels SPr, SPg, and SPb constituting one pixel (e.g., the first pixel PXL1) may be configured to emit light in different wavelength bands, respectively. For example, the red sub-pixel SPr may be configured to emit light in a red wavelength band. For example, the green sub-pixel SPg may be configured to emit light in a green wavelength band. For example, the blue sub-pixel SPb may be configured to emit light in a blue wavelength band. In accordance with one or more embodiments, one pixel may include two or more green sub-pixels SPg configured to emit green light.

The red wavelength band may be a wavelength band of about 600 nm (nanometers) to about 750 nm. The green wavelength band may be a wavelength band of about 480 nm to about 560 nm. The blue wavelength band may be a wavelength band of about 370 nm to about 460 nm.

In embodiments of the present disclosure, the sub-pixels constituting one pixel may be electrically connected to the corresponding data lines, respectively. For example, the red sub-pixel SPr, the green sub-pixel SPg, and the blue sub-pixel SPb of each of the first pixel PXL1 and the third pixel PXL3 may be electrically connected to three consecutive data lines DL(3k−2), DL(3k−1), and DL(3k) (where k is an integer greater than or equal to 1), respectively. For example, the red sub-pixel SPr, the green sub-pixel SPg, and the blue sub-pixel SPb of each of the second pixel PXL2 and the fourth pixel PXL4 may be electrically connected to three consecutive data lines DL(3k+1), DL(3k+2), and DL(3k+3), respectively.

In embodiments of the present disclosure, the sub-pixels constituting one pixel may be electrically connected to one reference voltage line. For example, the red sub-pixel SPr, the green sub-pixel SPg, and the blue sub-pixel SPb of each of the first pixel PXL1 and the third pixel PXL3 may be electrically connected to a k-th reference voltage line RVLK. For example, the red sub-pixel SPr, the green sub-pixel SPg, and the blue sub-pixel SPb of each of the second pixel PXL2 and the fourth pixel PXL4 may be electrically connected to a (k+1)-th reference voltage line RVL (k+1). However, embodiments of the present disclosure are not limited thereto. For example, the red sub-pixel SPr, the green sub-pixel SPg, and the blue sub-pixel SPb constituting one pixel may be electrically connected to different reference voltage lines, respectively.

In embodiments of the present disclosure, the sub-pixels constituting one pixel may be electrically connected to one scan line. For example, the red sub-pixel SPr, the green sub-pixel SPg, and the blue sub-pixel SPb of each of the first pixel PXL1 and the second pixel PXL2 may be electrically connected to an i-th scan line SLi (where i is an integer greater than or equal to 1). For example, the red sub-pixel SPr, the green sub-pixel SPg, and the blue sub-pixel SPb of each of the third pixel PXL3 and the fourth pixel PXL4 may be electrically connected to an (i+1)-th scan line SL(i+1).

In embodiments of the present disclosure, the pixels electrically connected to the same scan line may be understood as being located in the same row. Referring to FIG. 2, the first pixel PXL1 and the second pixel PXL2 connected to the i-th scan line SLi may be understood as being located in the same row (e.g., the i-th row). The third pixel PXL3 and the fourth pixel PXL4 connected to the (i+1)-th scan line SL(i+1) may be understood as being located in the same row (e.g., the (i+1)-th row).

In embodiments of the present disclosure, the pixels electrically connected to the same data line may be understood as being located in the same column. Referring to FIG. 2, the first pixel PXL1 and the third pixel PXL3 connected to a (3k−2)-th data line DL(3k−2), a (3k−1)-th data line DL(3k−1), and a 3k-th data line DL(3k) may be understood as being located in the same column (or a k-th column). The second pixel PXL2 and the fourth pixel PXL4 connected to a (3k+1)-th data line DL(3k+1), a (3k+2)-th data line DL(3k+2), and a (3k+3)-th data line DL(3k+3) may be understood as being located in the same column (or a (k+1)-th column).

In embodiments of the present disclosure, the plurality of pixels PXL may be arranged in two or more rows (or pixel rows) and two or more columns (or pixel columns) in the display area AA.

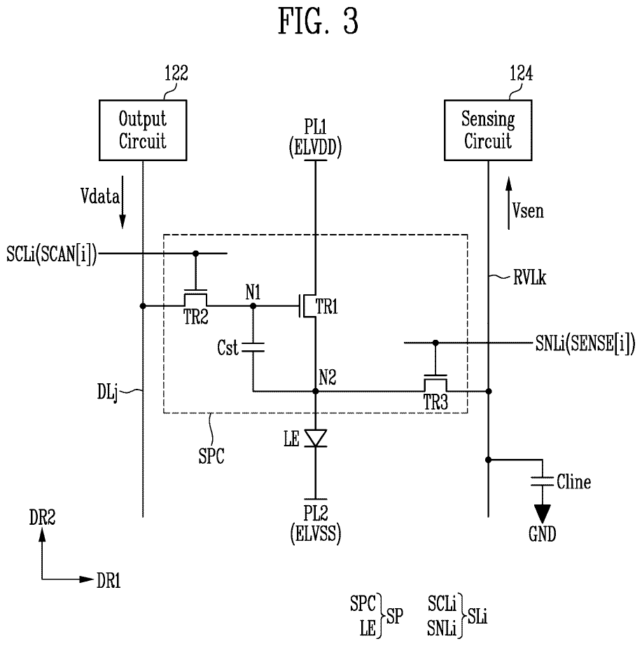

FIG. 3 is an equivalent circuit diagram of the sub-pixel SP in accordance with embodiments of the present disclosure.

The sub-pixel SP in accordance with embodiments of the present disclosure may include a light-emitting element LE and a pixel-driving circuit SPC configured to supply a current (e.g., a driving current) to the light-emitting element LE. The pixel circuit SPC may include two or more switching elements (e.g., transistors) and one or more storage elements (e.g., capacitors).

Referring to FIG. 3, the pixel circuit SPC in accordance with embodiments of the present disclosure may include a first transistor TR1, a second transistor TR2, a third transistor TR3, and a storage capacitor Cst. However, embodiments of the present disclosure are not limited thereto, and the configuration of the pixel circuit PXC may be freely implemented according to the design of those of ordinary skill in the art. Hereinafter, one or more embodiments in which the pixel circuit PXC includes first to third transistors TR1, TR2, and TR3 and a storage capacitor Cst is described as an example.

The light-emitting element LE may include a first electrode (one of an anode and a cathode), a second electrode (the remaining one of the anode and the cathode), and an emission layer. The emission layer may include, for example, an organic material and/or an inorganic material. For example, the light-emitting element LE may be implemented as an organic light-emitting diode (OLED) including an organic emission layer. For example, the light-emitting element LE may be implemented as an inorganic light-emitting diode including an inorganic emission layer. For example, the emission layer of the light-emitting element LE may include nanorods.

Referring to FIG. 3, the first electrode (e.g., the anode) of the light-emitting element LE may be electrically connected to a second node N2. The second electrode (e.g., the cathode) of the light-emitting element LE may be electrically connected to a second power line PL2.

A second power supply voltage ELVSS is applied to the second power line PL2. The second power supply voltage ELVSS may be, for example, a ground voltage or a low-potential voltage lower than the ground voltage.

The first transistor TR1 may be configured to switch an electrical connection between the first power line PL1 and the second node N2. The first transistor TR1 may include a gate electrode, a first electrode (one of a source electrode and a drain electrode), and a second electrode (the remaining one of the source electrode and the drain electrode). The gate electrode of the first transistor TR1 may be electrically connected to the first node N1. The first electrode (e.g., the drain electrode) of the first transistor TR1 may be electrically connected to the first power line PL1. The first power supply voltage ELVDD may be applied to the first power line PL1. The first power supply voltage ELVDD may be, for example, a high-potential voltage. The second electrode (e.g., the source electrode) of the first transistor TR1 may be electrically connected to the second node N2. A data voltage Vdata or a voltage corresponding to the data voltage Vdata may be applied to the first node N1. A current corresponding to the voltage applied to the first node N1 may flow through the first transistor TR1.

The second transistor TR2 may be configured to switch an electrical connection between a data line DLj and the first node N1. The operation timing of the second transistor TR2 may be controlled by a first scan signal SCAN[i]. The first scan signal SCAN[i] may be applied to an i-th first scan line SCLi (hereinafter abbreviated as a first scan line SCLi). The second transistor TR2 may be turned on in response to the first scan signal SCAN[i] of the turn-on level. When the second transistor TR2 is turned on, the data voltage Vdata may be applied to the first node N1.

The third transistor TR3 may be configured to switch an electrical connection between the second node N2 and the reference voltage line RVLK. The operation timing of the third transistor TR3 may be controlled by a second scan signal SENSE[i]. The second scan signal SENSE[i] may be applied to an i-th second scan line SNLi (hereinafter abbreviated as a second scan line SNLi). The third transistor TR3 may be turned on in response to the second scan signal SENSE[i] of the turn-on level. When the third transistor TR3 is turned on, the second node N2 and the reference voltage line RVLk may be electrically connected to each other. The voltage applied to the reference voltage line RVLk may be stored in a line capacitor Cline. The line capacitor Cline may be an intentionally and physically formed capacitor element rather than a parasitic capacitor. However, embodiments of the present disclosure are not limited thereto.

Referring to FIG. 3, each of the first to third transistors TR1 to TR3 may be a transistor including an N-type semiconductor layer. In this case, the turn-on level voltage of the first to third transistors TR1 to TR3 may be a high level voltage (e.g., a gate high voltage), and the turn-off level voltage thereof may be a low level voltage (e.g., a gate low voltage). In accordance with embodiments, at least one of the first to third transistors TR1 to TR3 may include a P-type semiconductor layer. In this case, the turn-on level voltage of the transistor including the P-type semiconductor layer may be a low level voltage (e.g., a gate low voltage), and the turn-off level voltage thereof may be a high level voltage (e.g., a gate high voltage).

At least one of the first to third transistors TR1 to TR3 may include a semiconductor layer of amorphous silicon (a-Si). At least one of the first to third transistors TR1 to TR3 may include a semiconductor layer of polycrystalline silicon (poly-Si). At least one of the first to third transistors TR1 to TR3 may include an oxide semiconductor layer including metal oxide.

The storage capacitor Cst may be configured to maintain the voltage difference between the first node N1 and the second node N2. The storage capacitor Cst may include one electrode electrically connected to the first node N1 and the other electrode electrically connected to the second node N2. The storage capacitor Cst may be an intentionally and physically formed capacitor element rather than a parasitic capacitor.

The output circuit 122 may output the data voltage Vdata to the data line DLj. The sensing circuit 124 may receive an analog sensing voltage Vsen applied to the reference voltage line RVLK.

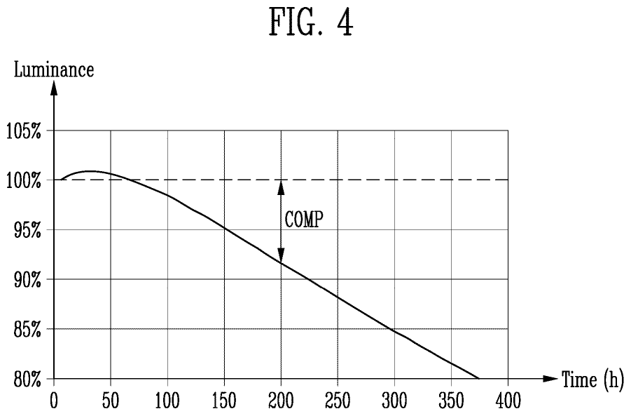

FIG. 4 is a diagram showing a luminance change curve over time.

Referring to FIG. 4, the luminance may be 100% at a time point represented as 0 hours (or 0 h). As the time passes, the luminance may increase slightly beyond 100%, and then may decrease as a whole. The luminance change curve may be referred to as a decay curve. In one or more embodiments, such luminance degradation that may occur in the organic light-emitting element may be referred to as a roll-off phenomenon. To compensate for such luminance change, a compensation value COMP may be applied. Due to the compensation value COMP, the luminance change may be compensated so that the luminance can be maintained at about 100%.

Meanwhile, such luminance change may appear differently depending on the gray scale. For example, the luminance change of low gray scale appears rapidly over time, while the luminance change of high gray scale appears relatively little. With reference to this, the low gray scale shows relatively fast luminance change, and thus, less time is suitable to determine the compensation value COMP. However, the high gray scale shows relatively slow luminance change, and thus, more time is suitable to determine the compensation value COMP.

In addition, as the physical properties of the organic light-emitting element improve, and as the lifetime of the organic light-emitting element increases, more time may be taken to determine the compensation value COMP. Therefore, it may be suitable to have a method for efficiently determining the compensation value COMP at high gray scale. Hereinafter, one or more embodiments of determining the compensation value COMP at a second gray scale (e.g., a high gray scale) by using the compensation value COMP obtained at a first gray scale (e.g., a low gray scale) is described.

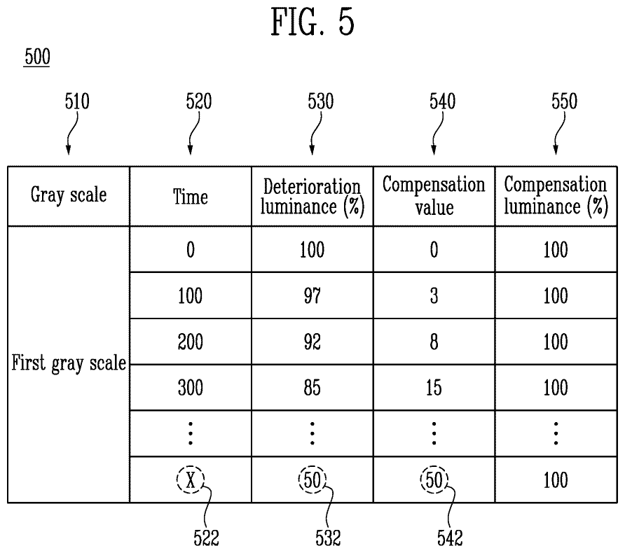

FIG. 5 illustrates one or more embodiments of a look-up table 500 including compensation values over time for a first gray scale.

Referring to FIG. 5, the look-up table 500 may include columns for gray scale 510, time 520, deterioration luminance 530, compensation value 540, and compensation luminance 550.

The gray scale 510 column indicates a gray scale value at which the luminance change is measured. Referring to FIG. 5, the luminance change may be measured for the first gray scale.

The time 520 column indicates a time point at which the luminance is measured (e.g., in hours). Referring to FIG. 5, an example of measuring luminance in units of 100 hours is illustrated. However, embodiments of the present disclosure are not limited thereto, and the luminance may be measured in units of less than 100 hours, or the luminance may be measured in units of greater than 100 hours. In one or more embodiments, the luminance may be measured at regular time intervals, but in one or more other embodiments, the luminance may be measured at irregular time intervals.

The deterioration luminance 530 column indicates the ratio of the luminance measured at each time, based on the luminance measured at 0 hours. For example, when the luminance of the first gray scale image measured at 0 hours is 100%, the luminance of the first gray scale image measured at 100 hours may be about 97%, the luminance of the first gray scale image measured at 200 hours may be about 92%, and the luminance of the first gray scale image measured at 300 hours may be about 85%.

The compensation value 540 column indicates a value suitable to maintain luminance at 100%. For example, when the luminance of the first gray scale image measured at 100 hours is about 97%, the compensation value suitable to maintain the luminance at 100% may be about 3 (or 3%). When the luminance of the first gray scale image measured at 200 hours is about 92%, the suitable compensation value may be about 8, and when the luminance of the first gray scale image measured at 300 hours is about 85%, the suitable compensation value may be about 15.

The compensation luminance 550 column indicates a value obtained by adding the compensation value 540 to the deterioration luminance 530. Accordingly, the compensation luminance 550 may be maintained at 100% as a whole.

Meanwhile, the look-up table 500 may include a corresponding time point 522 at which the deterioration luminance 530 becomes a target deterioration/degradation luminance 532.

In one or more embodiments, the target deterioration luminance 532 may be about 50%, and the corresponding time point 522 may be referred to as X. The compensation value 542 at the corresponding time point 522 may be about 50, and the compensation luminance 550 may be maintained at about 100%.

Referring to FIG. 5, the look-up table 500 is shown only for the first gray scale, but information for the second gray scale other than the first gray scale may be included. The look-up table 500 may be stored in the memory (see 142 of FIG. 1) of the timing controller (see 140 of FIG. 1).

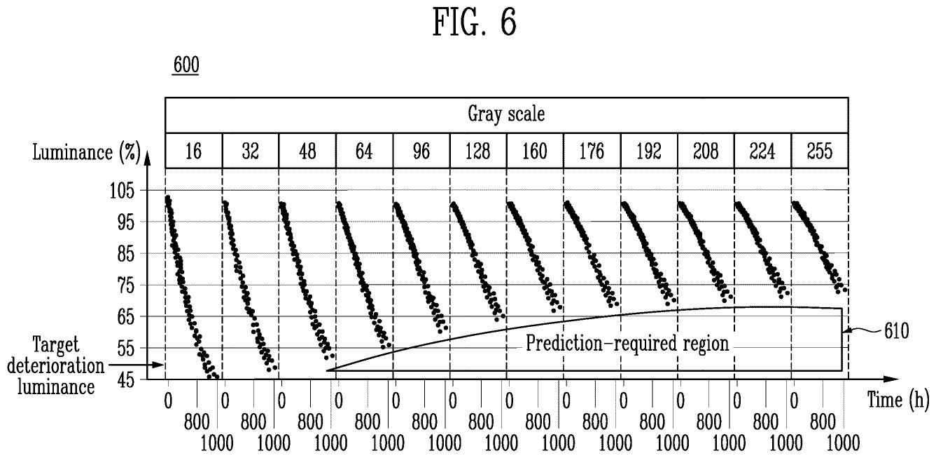

FIG. 6 is a diagram showing a luminance change curve 600 over time for each gray scale.

Referring to FIG. 6, there are shown curves for luminance change over time. The curves are respectively for 16 gray scale, 32 gray scale, 48 gray scale, 64 gray scale, 96 gray scale, 128 gray scale, 160 gray scale, 176 gray scale, 192 gray scale, 208 gray scale, 224 gray scale, and 255 gray scale. For each gray scale, the luminance change from 0 hours to 1,000 hours is shown.

Referring to FIG. 6, the 16 gray scale may reach the target deterioration luminance between 800 hours and 1,000 hours. In one or more embodiments, the target deterioration luminance may be about 50%, or half of the initial luminance.

The 32 gray scale may reach the target deterioration luminance at a time point close to 1,000 hours.

The 48 or more gray scale may reach the target deterioration luminance beyond 1,000 hours. With reference to this, the 48 to 255 gray scales may take over 1,000 hours until the time point at which the luminance is 50% is confirmed. The corresponding region may be referred to as a prediction-eligible region (e.g., prediction-required region) 610. The prediction-eligible region 610 may become larger in a direction from low gray scale to high gray scale.

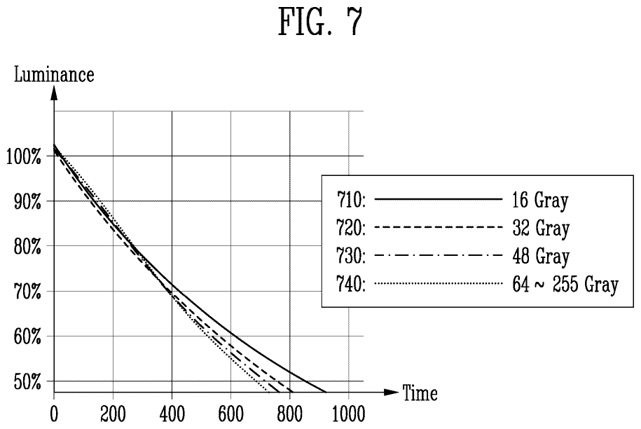

FIG. 7 is a diagram showing a scaled luminance change 700 over time for each gray level.

By plotting the luminance change over time for each gray scale, and by performing regression analysis based on the plotted data, a deterioration curve may be derived.

Referring to FIG. 7, a 16 gray scale deterioration curve 710, a 32 gray scale deterioration curve 720, a 48 gray scale deterioration curve 730, and a 64 gray scale deterioration curve 740 are illustrated. The corresponding deterioration curves may be scaled graphs.

With reference to this, scaled deterioration curves of 64 or more gray scale (e.g., 64 gray scale, 96 gray scale, 128 gray scale, 160 gray scale, 176 gray scale, 192 gray scale, 208 gray scale, 224 gray scale, 255 gray scale, etc.) may be configured similarly or substantially identically.

In one or more embodiments, the deterioration curve may be calculated as shown in Formula 1 below.

$$L ( t ) = {e}^{- ( \frac{t}{τ} ) β} \qquad Formula 1$$

In Formula 1, L (t) represents a luminance retention rate. The luminance retention rate represents the ratio of luminance at the time of measurement, compared to the initially measured luminance. When the luminance is maintained as it is, the luminance retention rate has a value of 1 (or 100%), and when the luminance decreases, the luminance retention rate has a value less than 1. In Formula 1, t represents time. T and β correspond to parameters determined through regression analysis.

For example, the scaled luminance change of the 255 gray scale image over time may be similar to the luminance change of the 64 gray scale image over time. Referring to Formula 1, τ and β may be set to be the same for each gray scale of 64 or more gray scales.

Accordingly, the luminance change of the 64 gray scale image over time may be calculated, and based on this, the luminance change of the 64 or more gray scale (e.g., 255 gray scale) over time may be calculated. Due to this, compensation values may be quickly calculated even for high gray scales that take a relatively long time to reach the target deterioration luminance.

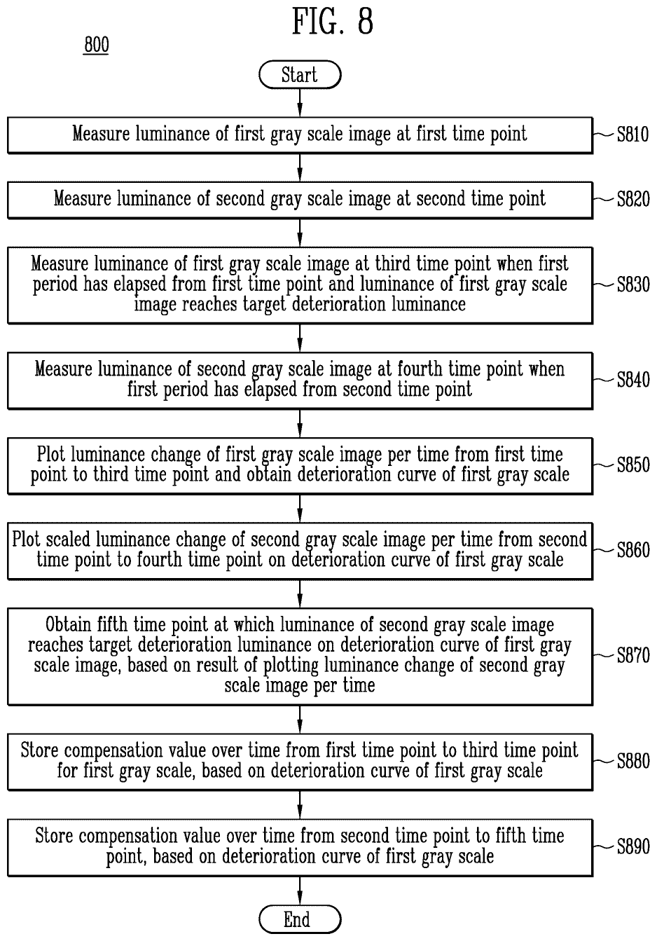

FIG. 8 is a flowchart of a compensation method 800 of a display device in accordance with embodiments of the present disclosure.

Referring to FIG. 8, the compensation method 800 of the display device in accordance with embodiments of the present disclosure may include measuring luminance of a first gray scale image at a first time point (S810), measuring luminance of a second gray scale image at a second time point (S820), measuring the luminance of the first gray scale image at a third time point when a first period has elapsed from the first time point (e.g., and when luminance of the first gray scale image reaches a target deterioration luminance) (S830), measuring the luminance of the second gray scale image at a fourth time point when the first period has elapsed from the second time point (S840), plotting a luminance change of the first gray scale image per time (e.g., over time) from the first time point to the third time point and obtaining a deterioration curve of a first gray scale (S850), plotting a scaled luminance change of the second gray scale image per time from the second time point to the fourth time point on the deterioration curve of the first gray scale (S860), obtaining a fifth time point at which the luminance of the second gray scale image reaches a target deterioration luminance on the deterioration curve of the first gray scale image, based on a result of plotting the luminance change of the second gray scale image per time (S870), storing a compensation value over time from the first time point to the third time point for the first gray scale, based on the deterioration curve of the first gray scale (S880), and storing a compensation value over time from the second time point to the fifth time point, based on the deterioration curve of the first gray scale (S890).

The first gray scale may be lower than the second gray scale. The target deterioration luminance may be about 50%. The luminance of the first gray scale image measured at the first time point may be about 100%, and the luminance of the first gray scale image measured at the third time point may be about 50%.

The deterioration curve of the first gray scale may be the deterioration curve described through Formula 1 above.

The luminance of the second gray scale image measured at the second time point may be about 100%, and the luminance of the second gray scale image measured at the fifth time point may be about 50%. The luminance of the second gray scale image measured at the fourth time point may be greater than about 50% and less than 100%.

The compensation value over time from the first time point to the third time point for the first gray scale may be stored in the timing controller (see 140 of FIG. 1) in the form of a look-up table. The compensation value over time from the second time point to the fifth time point for the second gray scale may be stored in the timing controller (see 140 of FIG. 1) in the form of a look-up table.

In the display device, the electronic device including the same, and the compensation method thereof in accordance with embodiments of the present disclosure, it is possible to efficiently calculate the compensation value of the light-emitting element and compensate for deterioration of the light-emitting element.

The drawings and detailed description of the present disclosure referred to so far are merely illustrative. This is used only for the purpose of explaining the present disclosure and is not used to limit the meaning or scope of the present disclosure set forth in the claims. Therefore, those skilled in the art will appreciate that various modifications and other equivalent embodiments are possible. Accordingly, the scope of the present disclosure should be defined by the appended claims, with functional equivalents thereof to be included therein.

What is claimed is:

1. A compensation method of a display device, the compensation method comprising:
measuring a luminance of a first gray scale image at a first time point;
measuring a luminance of a second gray scale image at a second time point;
measuring the luminance of the first gray scale image at a third time point when a first period has elapsed from the first time point;
measuring the luminance of the second gray scale image at a fourth time point when the first period has elapsed from the second time point;
plotting a luminance change of the first gray scale image over time from the first time point to the third time point;
obtaining a deterioration curve of a first gray scale;
plotting a scaled luminance change of the second gray scale image over time from the second time point to the fourth time point on the deterioration curve of the first gray scale;
obtaining a fifth time point at which the luminance of the second gray scale image reaches a target deterioration luminance on the deterioration curve of the first gray scale image based on a result of plotting the scaled luminance change of the second gray scale image over time;
storing a compensation value over time from the first time point to the third time point for the first gray scale based on the deterioration curve of the first gray scale; and
storing a compensation value over time from the second time point to the fifth time point based on the deterioration curve of the first gray scale.

2. The compensation method of claim 1, wherein the first gray scale is lower than the second gray scale.

3. The compensation method of claim 1, wherein the luminance of the first gray scale image measured at the third time point is equal to the target deterioration luminance.

4. The compensation method of claim 1, wherein the luminance of the second gray scale image measured at the fifth time point is equal to the target deterioration luminance.

5. The compensation method of claim 1, wherein the luminance of the first gray scale image measured at the first time point is about 100%, and the luminance of the first gray scale image measured at the third time point is 50%.

6. The compensation method of claim 1, wherein the luminance of the second gray scale image measured at the second time point is about 100%, and the luminance of the second gray scale image measured at the fifth time point is about 50%.

7. The compensation method of claim 6, wherein the luminance of the second gray scale image measured at the fourth time point is greater than about 50% and less than about 100%.

8. The compensation method of claim 1, further comprising storing compensation values over time for gray scales between the first gray scale and the second gray scale based on the deterioration curve of the first gray scale.

9. The compensation method of claim 1, wherein the compensation value over time from the first time point to the third time point, and the compensation value over time from the second time point to the fifth time point, are stored as a look-up table.

10. The compensation method of claim 1, wherein the first gray scale is a 64 gray scale.

11. A display device comprising:
a display panel;
sub-pixels on the display panel;
a data-driving circuit configured to sense a degree of deterioration of the sub-pixels, and to supply a data voltage to the sub-pixels; and
a timing controller configured to receive first image data, and to output, to the data-driving circuit, second image data obtained by compensating the first image data based on a compensation value over time that is stored for gray scales according to the degree of deterioration of the sub-pixels,
wherein the compensation value over time that is stored for the gray scales comprises a compensation value for a first gray scale and a compensation value for a second gray scale, and
wherein the compensation value for the second gray scale is based on the compensation value for the first gray scale.

12. The display device of claim 11, wherein the first gray scale is lower than the second gray scale.

13. The display device of claim 11, wherein the compensation value for the first gray scale is based on a deterioration curve of the first gray scale obtained by plotting a luminance change of the first gray scale over time from a first time point to a third time point.

14. The display device of claim 13, wherein a luminance of a first gray scale image at the third time point is half of a luminance of the first gray scale image at the first time point.

15. The display device of claim 13, wherein a fifth time point is obtained by plotting the compensation value for the second gray scale on the deterioration curve of the first gray scale by scaling a luminance change of the second gray scale over time from a second time point to a fourth time point, and
wherein a compensation value of the second gray scale over time obtained from the second time point to the fifth time point based on the deterioration curve of the first gray scale is configured to be stored.

16. The display device of claim 15, wherein a luminance of a second gray scale image at the fifth time point is half of a luminance of the second gray scale image at the second time point.

17. The display device of claim 15, wherein a luminance of a second gray scale image at the fourth time point is greater than a luminance of the second gray scale image at the fifth time point, and less than luminance of the second gray scale image at the second time point.

18. The display device of claim 11, wherein the first gray scale is a 64 gray scale, and
wherein the second gray scale is greater than a 64 gray scale and less than or equal to a 255 gray scale.

19. The display device of claim 11, wherein the timing controller comprises a memory in which a look-up table is stored, the look-up table storing a compensation value over time for the gray scales.

20. An electronic device comprising:
a host configured to output a first image data;
a display panel;
sub-pixels on the display panel;
a data-driving circuit configured to sense a degree of deterioration of the sub-pixels, and to supply a data voltage to the sub-pixels; and
a timing controller configured to receive the first image data, and to output, to the data-driving circuit, second image data obtained by compensating the first image data based on a compensation value over time that is stored for gray scales according to the degree of deterioration of the sub-pixels,
wherein the compensation value over time that is stored for the gray scales comprises a compensation value for a first gray scale and a compensation value for a second gray scale, and
wherein the compensation value for the second gray scale is based on the compensation value for the first gray scale.
